(19) United States
(12) Patent Application Publication
(10) Pub. No.: US 2014/0085802 A1
(43) Pub. Date: Mar. 27, 2014

(54) SERVER AND HOST MODULE THEREOF

(71) Applicants: INVENTEC CORPORATION, Taipei (TW); Inventec (Pudong) Technology Corporation, Shanghai (CN)

(72) Inventors: Qi-Guang Ning, Shanghai (CN); Ji-Peng Xu, Shanghai (CN); Yu-Long Shen, Shanghai (CN)

(21) Appl. No.: 13/785,075

(22) Filed: Mar. 5, 2013

(30) Foreign Application Priority Data
Sep. 21, 2012 (CN) 201210353284.3

(51) Int. Cl. G06F 1/18; G06F 1/20

(52) U.S. Cl. CPC G06F 1/181; G06F 1/20
USPC 361/679.31

(57) ABSTRACT

A server comprises a cabinet and a host module placed inside or taken outside the cabinet along a rail. The host module comprises a supporting tray, a motherboard, a system storage device, a processing module and a stored data controlling module. The motherboard and the system storage device are disposed in the supporting tray and are electrically connected with each other. The processing module for executing an operating system stored in the system storage device is electrically connected to the system storage device via the motherboard. The stored data controlling module is disposed in the supporting tray and electrically connected to the motherboard. When the host module is placed inside the cabinet, the stored data controlling module is electrically connected to a data storage device. The stored data controlling module is controlled by the processing module to access data from or store data in the data storage device.

### CROSS-REFERENCE TO RELATED APPLICATIONS

This non-provisional application claims priority under 35 U.S.C. §119(a) on Patent Application No(s). 201210353284.3 filed in China on Sep. 21, 2012, the entire contents of which are hereby incorporated by reference.

### BACKGROUND OF THE INVENTION

1. Technical Field of the Invention

The present disclosure relates to a server and its host module and more particularly to a server for accessing data and its host module.

2. Description of the Related Art

Nowadays, server is usually used for processing, accessing and storing internet data. Computers of user end can be connected to a server through which data are computed, accessed and stored. The users are able to browse and exchange data via the server.

However, as electronic products such as mobile communication devices, tablet computer and personal computer are becoming popular, the number of internet users keeps increasing. Furthermore, the amount of information on the internet has also rapidly increased. The amount of information accessed and stored by servers is increased sharply due to the increasing demand from the users and tremendous amount of data available on the internet. Nowadays, slow accessing and storing speed or errors occurred in accessing and storing of data are common problems for servers as the amount of information required for accessing and storing is tremendous. Therefore, it is highly demanded for the industry to develop a server by which data or information can be accessed and stored speedily and accurately.

### SUMMARY OF THE INVENTION

In view of the above problems, a server of the present disclosure is provided by which data or information can be accessed and stored speedily and accurately.

A server provided in an embodiment of the present disclosure comprises a cabinet and a host module. The cabinet comprises a frame, a rail and a data storage device accommodating rack. The rail is disposed inside the frame. The data storage device accommodating rack is disposed inside the frame. The data storage device accommodating rack is used for accommodating a data storage device. The host module can be placed inside or taken outside the cabinet along the rail. The host module comprises a supporting tray, a motherboard, a system storage device, a processing module and a stored data controlling module. The motherboard is disposed in the supporting tray. The system storage device is also disposed in the supporting tray and electrically connected to the motherboard. The system storage device is used for storing an operating system. The processing module is disposed on the motherboard and electrically connected to the system storage device via the motherboard. The processing module is used for executing the operating system. The stored data controlling module is disposed in the supporting tray and electrically connected to the motherboard. When the host module is placed inside the cabinet, the stored data controlling module is electrically connected to the data storage device. The stored data controlling module can be controlled by the processing module to access data from or store data in the data storage device.

According to an embodiment of the present disclosure, the cabinet further comprises a circuit board. The circuit board is disposed inside the frame. When the host module is placed inside the cabinet, the circuit board is electrically connected to the data storage device and the stored data controlling module.

According to an embodiment of the present disclosure, the host module further comprises a interconnecting board. The interconnecting board is electrically connected to the motherboard and the stored data controlling module. When the host module is placed inside the cabinet, the motherboard and the stored data controlling module are electrically connected to the circuit board via the interconnecting board.

According to an embodiment of the present disclosure, the cabinet further comprises a connecting vertical plate. The connecting vertical plate is inserted on the circuit board for electrically connecting to the circuit board. When the host module is placed inside the cabinet, the interconnecting board is inserted in the connecting vertical plate for electrically connecting to the connecting vertical plate.

According to an embodiment of the present disclosure, the host module further comprises a modular vertical plate inserted on the motherboard for electrically connecting to the motherboard. The stored data controlling module is electrically connected to the modular vertical plate.

According to an embodiment of the present disclosure, the cabinet further comprises a power supply module and a bottom plate. The power supply module is disposed inside the frame and between the rail and the bottom plate. When the host module is placed inside the cabinet, the motherboard is electrically connected to the power supply module.

According to an embodiment of the present disclosure, the host module further comprises a interconnecting board. When the host module is placed inside the cabinet, the interconnecting board is electrically connected to the stored data controlling module and the power supply module, as well as to the motherboard and the power supply module.

According to an embodiment of the present disclosure, the system storage device and the stored data controlling module are suspended above the motherboard.

According to an embodiment of the present disclosure, the cabinet further comprises a fan module. The fan module is detachably inserted inside the frame and is disposed between the rail and the data storage device accommodating rack.

According to an embodiment of the present disclosure, the cabinet further comprises a circuit board and a bottom plate. The circuit board is disposed inside the frame and between the fan module and the bottom plate. The fan module is electrically connected to the circuit board.

A host module further provided in another embodiment of the present disclosure comprises supporting tray, a motherboard, a system storage device, a processing module and a stored data controlling module. The motherboard is disposed in the supporting tray. The system storage device is disposed in the supporting tray and electrically connected to the motherboard. The system storage device is used for storing an operating system. The processing module is disposed on the motherboard and electrically connected to the system storage device via the motherboard. The processing module is used for executing the operating system. The stored data controlling module is disposed in the supporting tray and electrically connected to the motherboard. When the host module is electrically connected to a data storage device, the stored data controlling module is electrically connected to the data storage device. The stored data controlling module can be controlled by the processing module to access data from or store data in the data storage device.

According to an embodiment of the present disclosure, the host module further comprises a interconnecting board. The interconnecting board is electrically connected to the motherboard and the stored data controlling module. When the host module is electrically connected to the data storage device, the motherboard and the stored data controlling module are electrically connected to the data storage device via the interconnecting board.

According to an embodiment of the present disclosure, the host module further comprises a interconnecting board. When the host module is electrically connected to a power supply module, the interconnecting board is electrically connected to the stored data controlling module and the power supply module, as well as to the motherboard and the power supply module.

According to an embodiment of the present disclosure, the system storage device and the stored data controlling module are suspended above the motherboard.

According to the server and its host module of the present disclosure, data can be accessed and stored by the stored data controlling module independent from the processing module. The stored data controlling module is used to access and store the stored data in the data storage device, and the data accessed and stored is transmitted back to the processing module. Thereby, the speed for accessing and storing the data can be enhanced and the occurrence of errors can be reduced in order to enhance the stability and maintain the system computing speed.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of a server according to an embodiment of the disclosure;

FIG. 2 is a partial exploded view of the server of FIG. 1; and

FIG. 3 is a schematic view of a host module of FIG. 2 from another direction.

### DETAILED DESCRIPTION OF THE EXEMPLARY EMBODIMENTS

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

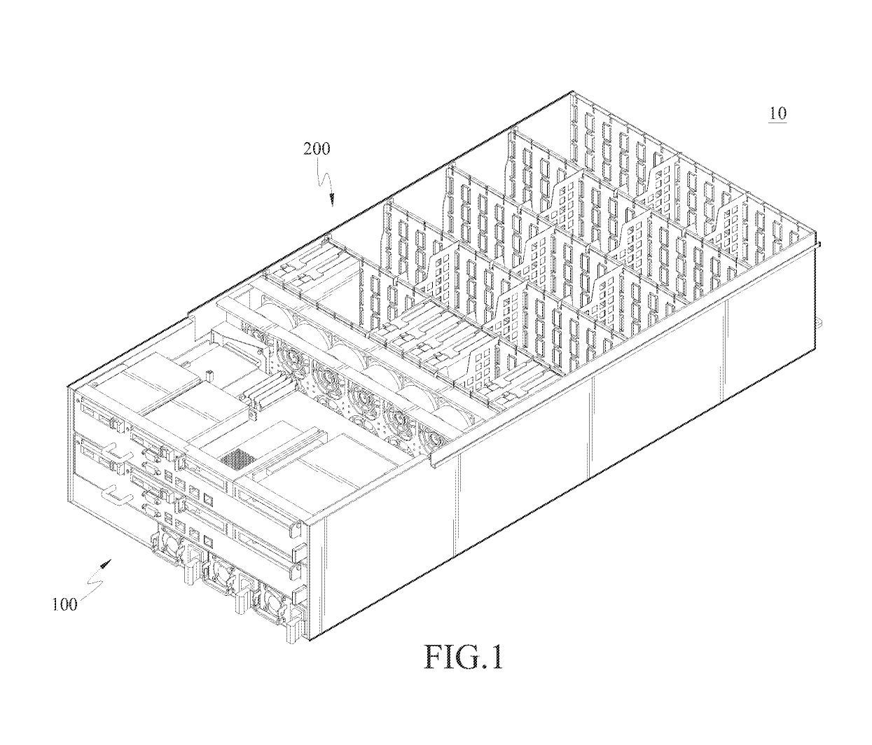

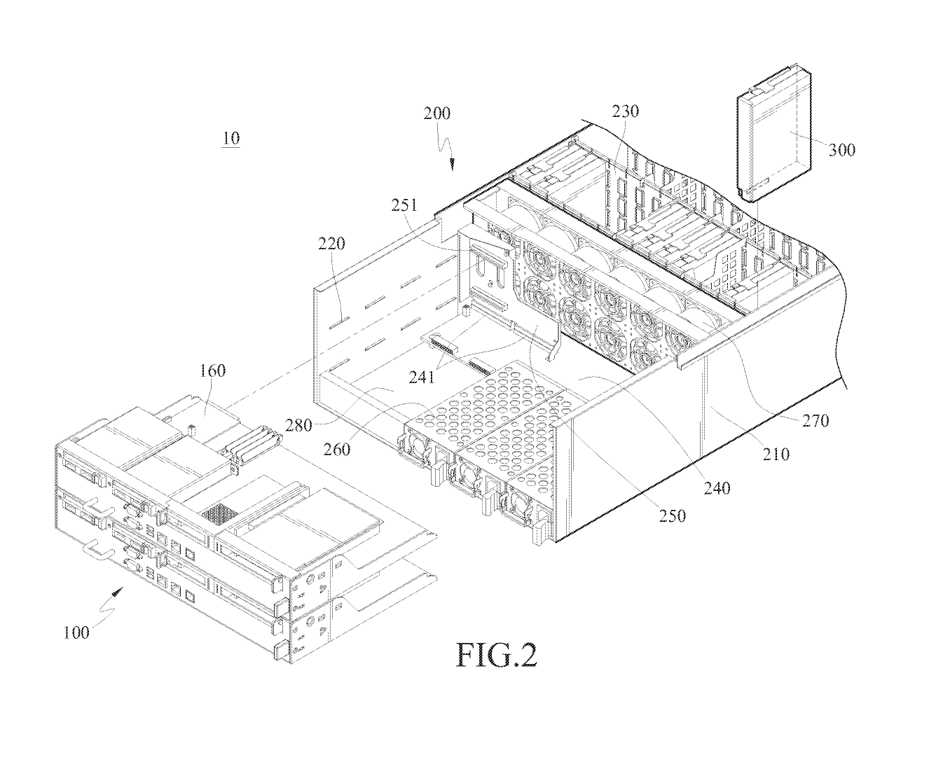

Please refer to FIG. 1. FIG. 1 is a schematic view of a server 10 according to an embodiment of the disclosure. The server 10 comprises a cabinet 200 and a plurality of host modules 100. Please refer to FIG. 2. FIG. 2 is a partial exploded view of the server 10 of FIG. 1. The cabinet 200 comprises a frame 210, a rail 220, a data storage device accommodating rack 230, a circuit board 240, a connecting vertical plate 250, a power supply module 260, a fan module 270 and a bottom plate 280. The rail 220 is inside the frame 210. The data storage device accommodating rack 230 is also inside the frame 210. The data storage device accommodating rack 230 is configured for accommodating a plurality of data storage devices 300. The host modules 100 is able to be inserted into or taken out of the cabinet 200 along the rail 220. The circuit board 240 is inside the frame 210. When the data storage devices 300 are accommodated inside the data storage device accommodating rack 230, the data storage devices 300 is electrically connected to the circuit board 240. Thereby, the circuit board 240 is able to communicate with the data storage devices 300 and integrates the data in the data storage devices 300. The connecting vertical plate 250 is inserted in slots 241 of the circuit board 240 for electrically connecting to the circuit board 240. The power supply module 260 is disposed inside the frame 210 and between the rail 220 and the bottom plate 280. The power supply module 260 is electrically connected to the circuit board 240 to supply electric power to the connecting vertical plate 250 and each of the data storage devices 300, so that stable power supply is provided for the data storage devices 300. The fan module 270 is vertically and detachably disposed inside the frame 210 and is disposed between the rail 220 and the data storage device accommodating rack 230. The circuit board 240 is disposed between the fan module 270 and the bottom plate 280. The fan module 270 is electrically connected to the circuit board 240.

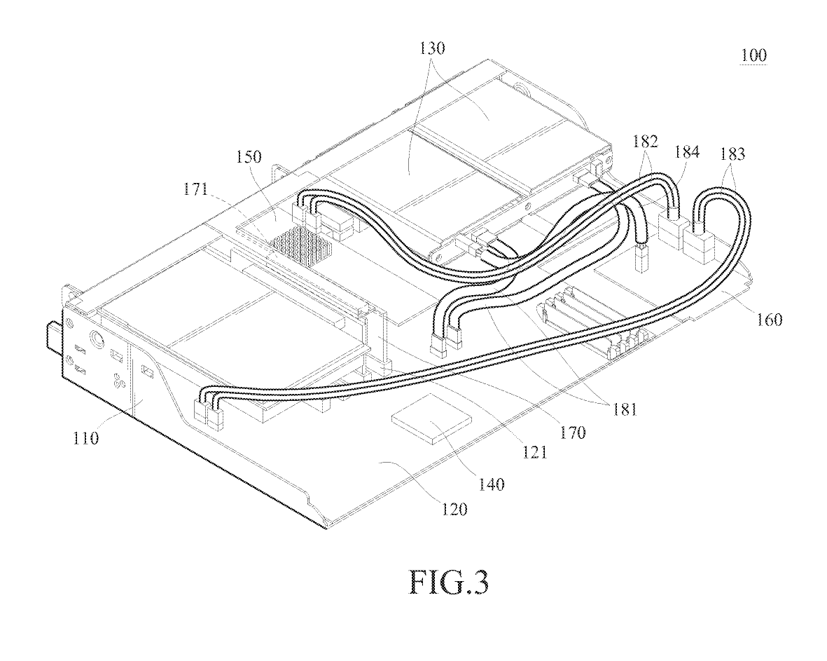

Please refer to FIGS. 2 and 3. FIG. 3 is a schematic view of the host module 100 of FIG. 2 in another direction. The host module 100 comprises a supporting tray 110, a motherboard 120, a system storage device 130, a processing module 140, a stored data controlling module 150, an interconnecting board 160 and a modular vertical plate 170. The motherboard 120 is disposed in the supporting tray 110. The system storage device 130 is also disposed in the supporting tray 110 and is suspended above the motherboard 120. The system storage device 130 is electrically connected to the motherboard 120 via a plurality of cables 181. The system storage device 130 is used for storing an operating system. The processing module 140 is disposed on the motherboard 120 and electrically connected to the system storage device 130 via the motherboard 120 and the cables 181. The processing module 140 is used for running the operating system stored in the system storage device 130. The stored data controlling module 150 is disposed in the supporting tray 110 and suspended above the motherboard 120. The interconnecting board 160 is disposed by an edge of the supporting tray 110. The interconnecting board 160 is electrically connected to the stored data controlling module 150 via a plurality of cables 182. The interconnecting board 160 is electrically connected to the motherboard 120 via a plurality of cables 183. The interconnecting board 160 is electrically connected to the system storage device 130 via a cable 184. The modular vertical plate 170 is inserted in a slot 121 of the motherboard 120 for electrically connecting to the motherboard 120. The stored data controlling module 150 is inserted in a slot 171 of the modular vertical plate 170 for electrically connecting to the modular vertical plate 170, and then electrically connecting to the motherboard 120 via the modular vertical plate 170. Because the system storage device 130 and the stored data controlling module 150 are suspended above the motherboard 120, the area occupied horizontally by the host module 100 can be reduced, and the overall size of the server 10 can also be reduced. Thereby, it is favorable for storing the server 10.

The system storage device 130 is, for example, a hard disk stored with an operating system. The processing module 140 is, for example, a central processing unit. The stored data controlling module 150 can comprise a chip for data accessing and storing. The data storage devices 300 are, for example, hard disks stored with data.

When the host module 100 is placed inside the cabinet 200, the interconnecting board 160 is inserted in a slot 251 of the connecting vertical plate 250 for electrically connecting to the connecting vertical plate 250. The circuit board 240 is electrically connected to the data storage devices 300 and the stored data controlling module 150 via the connecting vertical plate 250, the interconnecting board 160 and the cables 182. In other words, the stored data controlling module 150 is electrically connected to the circuit board 240 via the interconnecting board 160. The motherboard 120 is electrically connected to the circuit board 240 via the interconnecting board 160. The power supply module 260 is disposed between the host module 100 and the bottom plate 280. Thereby, the motherboard 120 can be electrically connected to the data storage devices 300 via the interconnecting board 160 and the circuit board 240. Furthermore, the interconnecting board 160 can provide electric power for each of the host modules 100 via the connecting vertical plate 250. Therefore, the interconnecting board 160 is electrically connected to the stored data controlling module 150 and the power supply module 260 for providing the stored data controlling module 150 with electric power. The interconnecting board 160 is also electrically connected to the motherboard 120 and the power supply module 260 for providing the motherboard 120 with electric power.

Because the motherboard 120 is electrically connected to the interconnecting board 160 via the cables 183, and then electrically connected to the power supply module 260 via the connecting vertical plate 250 and the circuit board 240; the motherboard 120 can receive the electric power provided by the power supply module 260. The motherboard 120 can further provide electric power for the processing module 140. Because the stored data controlling module 150 is electrically connected to the motherboard 120 via the modular vertical plate 170, the motherboard 120 can also provided electric power for the stored data controlling module 150. Additionally, because the stored data controlling module 150 can be electrically connected to the interconnecting board 160 via the cables 183, and then electrically connected to the power supply module 260 via the connecting vertical plate 250 and the circuit board 240, the stored data controlling module 150 can receive the electric power provided by the power supply module 260 directly.

The stored data controlling module 150 for accessing and storing the data of the data storage devices 300 is independent of the processing module 140. The stored data controlling module 150 is electrically connected to the motherboard 120 via the modular vertical plate 170; electrically connected to the interconnecting board 160 via the cables 183; electrically connected to the circuit board 240 via the connecting vertical plate 250; and then electrically connected to the data storage devices 300. Furthermore, the processing module 140 is electrically connected to the stored data controlling module 150 via the motherboard 120 and the modular vertical plate 170 to control the stored data controlling module 150. The stored data controlling module 150 can be controlled by the processing module 140 to access data from or store data in the data storage devices 300. After the stored data controlling module 150 has accessed and stored the data in the data storage devices 300, the accessed and stored data can be transmitted back to the processing module 140 for the processing module 140 to carry out subsequent tasks. If a large amount of data is accessed and stored in the data storage devices 300 directly while the processing module 140 is performing computing, a large amount of resources of the processing module 140 are therefore occupied. As a result, the speed of accessing and storing the data is reduced, the occurrence of errors is increased and the computing speed of the system is reduced. However, a large amount of resources of the processing module 140 can be avoided from being occupied by the accessing and storing of data if a large amount of stored data in the data storage devices 300 is accessed and stored by the stored data controlling module 150 first, and then the accessed and stored data is transmitted back to the processing module 140. As a result, besides that the speed of accessing and storing the data is increased, the occurrence of errors is reduced and the computing speed of the system is increased as well.

In some embodiments, the processing module 140 can be electrically connected to the interconnecting board 160 via the motherboard 120 and the cables 183, and then electrically connected to the stored data controlling module 150 via the cables 182 to control the stored data controlling module 150. Additionally, the processing module 140 is electrically connected to the interconnecting board 160 via the motherboard 120 and the cables 183, electrically connected to the circuit board 240 via the connecting vertical plate 250, and then electrically connected to the data storage devices 300. Therefore, the processing module 140 can directly access data from and store data in the data storage devices 300.

According to the server and its host module of the present disclosure, by using the stored data controlling module to access and store the data in the data storage devices, and the accessed and stored data is transmitted back to the processing module; the speed for accessing and storing the data can be enhanced and the occurrence of errors can be reduced in order to enhance the stability and maintain the system computing speed. Because the system storage devices and the stored data controlling module are suspended above the motherboard, the area occupied horizontally by the host modules can be reduced, and the overall size of the server can also be reduced. Thereby, it is favorable for storing the server. Electric power is distributed via the circuit board to each of the host modules and each of the data storage devices. Therefore, stable power supply can be provided for the host modules and the data storage devices.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A server, comprising:
a cabinet, comprising:
a frame;
a rail disposed inside the frame; and
a data storage device accommodating rack disposed inside the frame, the data storage device accommodating rack being adapted to accommodate a data storage device; and
a host module adapted to be inserted into or taken out of the cabinet along the rail, the host module comprising:
a supporting tray;
a motherboard disposed in the supporting tray;
a system storage device disposed in the supporting tray and electrically connected to the motherboard, the system storage device being adapted to store an operating system;
a processing module disposed on the motherboard and electrically connected to the system storage device via the motherboard, the processing module being adapted to run the operating system; and
a stored data controlling module disposed in the supporting tray and electrically connected to the motherboard, when the host module is inserted in the cabinet, the stored data controlling module is electrically connected to the data storage device, and the stored data controlling module is controlled by the processing module to access data from or store data in the data storage device.

2. The server as claimed in claim 1, wherein the cabinet further comprises a circuit board, the circuit board is disposed inside the frame, when the host module is placed inside the cabinet, the circuit board is electrically connected to the data storage device and the stored data controlling module.

3. The server as claimed in claim 2, wherein the host module further comprises a interconnecting board, the interconnecting board is electrically connected to the motherboard and the stored data controlling module, when the host module is placed inside the cabinet, the motherboard and the stored data controlling module are electrically connected to the circuit board via the interconnecting board.

4. The server as claimed in claim 3, wherein the cabinet further comprises a connecting vertical plate, the connecting vertical plate is inserted on the circuit board for electrically connecting to the circuit board, when the host module is placed inside the cabinet, the interconnecting board is inserted in the connecting vertical plate for electrically connecting to the connecting vertical plate.

5. The server as claimed in claim 1, wherein the host module further comprises a modular vertical plate inserted on the motherboard for electrically connecting to the motherboard, the stored data controlling module is electrically connected to the modular vertical plate.

6. The server as claimed in claim 1, wherein the cabinet further comprises a power supply module and a bottom plate, the power supply module is disposed inside the frame and between the rail and the bottom plate, when the host module is placed inside the cabinet, the motherboard is electrically connected to the power supply module, and the power supply module is disposed between the host module and the bottom plate.

7. The server as claimed in claim 6, wherein the host module further comprises a interconnecting board, when the host module is placed inside the cabinet, the interconnecting board is electrically connected to the stored data controlling module and the power supply module, as well as to the motherboard and the power supply module.

8. The server as claimed in claim 7, wherein the system storage device and the stored data controlling module are suspended above the motherboard.

9. The server as claimed in claim 1, wherein the cabinet further comprises a fan module, the fan module is detachably inserted inside the frame and is disposed between the rail and the data storage device accommodating rack.

10. The server as claimed in claim 9, wherein the cabinet further comprises a circuit board and a bottom plate, the circuit board is disposed inside the frame and between the fan module and the bottom plate, the fan module is electrically connected to the circuit board.

11. A host module, comprising:
a supporting tray;
a motherboard disposed in the supporting tray;
a system storage device disposed in the supporting tray and electrically connected to the motherboard, the system storage device being used for storing an operating system;
a processing module disposed on the motherboard and electrically connected to the system storage device via the motherboard, the processing module being used for executing the operating system; and
a stored data controlling module disposed in the supporting tray and electrically connected to the motherboard, when the host module being electrically connected to a data storage device, the stored data controlling module being electrically connected to the data storage device, and the stored data controlling module being controlled by the processing module to access data from or store data in the data storage device.

12. The host module as claimed in claim 11, wherein the host module further comprises a interconnecting board, the interconnecting board is electrically connected to the motherboard and the stored data controlling module, when the host module is electrically connected to the data storage device, the motherboard and the stored data controlling module are electrically connected to the data storage device via the interconnecting board.

13. The host module as claimed in claim 11, wherein the host module further comprises a interconnecting board, when the host module is electrically connected to a power supply module, the interconnecting board is electrically connected to the stored data controlling module and the power supply module, as well as to the motherboard and the power supply module.

14. The host module as claimed in claim 11, wherein the system storage device and the stored data controlling module are suspended above the motherboard.
